(19) United States
(12) Patent Application Publication
(10) Pub. No.: US 2023/0418339 A1
(43) Pub. Date: Dec. 28, 2023

(54) AUTOMATICALLY OPEN LAPTOP HINGE

(71) Applicant: Intel Corporation, Santa Clara, CA (US)

(72) Inventor: Chunlin BAI, Shenzhen, Guangdong (CN)

(21) Appl. No.: 18/036,823

(22) PCT Filed: Dec. 22, 2020
(86) PCT No.: PCT/CN2020/138235

§ 371 Date: May 12, 2023

(51) Int. Cl. G06F 1/16; F16C 11/04

(52) U.S. Cl. CPC G06F 1/1681; F16C 11/04; E05D 3/02; E05Y 2201/426; E05Y 2201/486; E05Y 2900/606

(57) ABSTRACT

A hinge system for a laptop computer is disclosed, the hinge system comprising first and second hinges that are tied together using a spring wire. The first and second hinges each have a display portion attached to a laptop computer display and a base portion attached to the laptop computer base. The spring wire is affixed to the display portion of the first hinge and the base portion of the second hinge, and is preloaded so that the laptop computer display opens automatically away at least partially away from the laptop computer base.

### TECHNICAL FIELD

Embodiments described herein generally relate to laptop computers, and in particular to laptop computer hinges that are configured to automatically at least partially open from a closed position.

### BACKGROUND

Over the history of portable computing, computers have been manufactured in increasingly smaller form factors. Some of the first portable computers were essentially the size of a suitcase, as they essentially employed the components and modular construction of a desktop computer, albeit typically with a small integrated monitor. Over time, the constituent components of laptop computers began to shrink in size and/or be optimized for portability. With the advent of acceptable flat panel display technology, laptop computers began to appear in their present form, namely a clamshell configuration with a keyboard in a base and a display panel hinged to an edge of the base. While laptop computers have continued to decrease in size while increasing in computing power, integration of internal components and so forth, this clamshell form factor has remained over the years as the standard laptop configuration.

### BRIEF DESCRIPTION OF THE DRAWINGS

FIG. 1 is a perspective view of an example spring-biased hinge system for a laptop computer, according to various embodiments.

FIG. 2 is a perspective view of the left side hinge of the example hinge system of FIG. 1, according to various embodiments.

FIG. 3 is a perspective view of the right side hinge of the example hinge system of FIG. 1, according to various embodiments.

FIG. 4 is an exploded view of the left side hinge depicted in FIG. 2, according to various embodiments.

FIG. 5 is an exploded view of the right side hinge depicted in FIG. 3, according to various embodiments.

FIG. 6 is a profile view of an example laptop illustrating various opening ranges, according to various embodiments.

FIG. 7 is a flowchart of operations of an example method for deploying a spring-biased hinge system, according to various embodiments.

### DESCRIPTION OF EMBODIMENTS

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “iterative”, “iteratively”, “repeated” and “repeatedly” mean executing an action at discrete intervals on a regular or ad hoc basis, potentially for an indefinite period of time, and/or until a stop condition is met or the action is otherwise halted. The terms contrast to an action that is executed “continuously”, meaning the action is ongoing without interruption until a stop condition is met or the action is otherwise halted.

For a typical clamshell style laptop computer, the base portion, with the keyboard, provides a stable anchor while the computer is in use. The display portion is typically attached to the base portion with one or more hinges that join an edge of the base portion to an edge of the display portion. The hinges may serve as a protected path to route cables/wires from the base portion to the display portion. These hinges may determine the extent to which the display can open away from the base portion. In a typical laptop computer, these one or more hinges not only hold the display portion to the base portion, they may also serve to hold the display portion at an angle as desired by a user of the laptop computer.

To hold at a given angle, the one or more hinges may be configured to provide a resistance or friction from movement. This resistance or friction, as will be understood, is typically calibrated to be sufficiently greater than the weight of the display portion so that the display portion is held at whatever angle the user places the display portion, and does not move under its own weight to a fully closed or fully open position. However, this resistance or friction may further be calibrated to be sufficiently light so that the display portion can be moved with minimal to no movement of the base portion, to help facilitate ease of use of the laptop computer.

Achieving a balance between friction or resistance sufficient to hold the display portion at a selected position while allowing the display portion to be moved without significant movement of the base portion requires selecting a friction or resistance that is greater than the weight of the display portion, but lighter than the weight of the base portion. If the friction or resistance exceeds the weight of the base portion, opening the laptop computer will be impossible without using two hands; one hand to lift the display portion while the other holds the base in place. Requiring a user to employ both hands to open a laptop computer may be undesirable.

As laptop computer components have decreased in size, laptop weight has likewise decreased. This weight savings has been achieved in part by combining and integrating various components, such as employing a System on a Chip (SoC). A SoC, potentially combining memory, graphics, and processing facilities on a single carrier, can allow a laptop computer's main logic board to be manufactured in very small form factor. As a result, modern laptop computers can have weights less than two pounds, with a display portion of the laptop clamshell potentially weighing within a few ounces of the base/keyboard portion. These close weights between base and display portions can make achieving a friction or resistance that holds the display portion in place while not requiring two hands to open the laptop computer challenging, if not impossible, to achieve.

Disclosed embodiments address these challenges by including a spring wire that links two hinges of a laptop, and provides a biasing force to urge the hinges into an open position. The spring wire may be installed in a neutral position, e.g. relaxed and not exerting a force, when the hinges are at an approximately 90 degree open position. This position may correspond to a display portion extending orthogonally from a base portion. When the display portion is closed in such embodiments, the hinges are forced into a closed position, causing the spring wire to be tensioned and to bias the hinges towards an open position. The display portion may be retained to the base portion in a closed configuration using some sort of a latching or retaining mechanism. When such a laptop computer is opened, the bias provided by the spring wire can cause the display portion to open away from the base portion automatically. Because the bias of the spring is directed against both the display portion and the base portion, the base portion is biased towards whatever surface upon which it is sitting. Consequently, a user may be able to open the laptop with one hand, e.g. by unlocking or unlatching the display portion from the base portion, with the spring wire providing a counter force against the base portion to allow the user to further open the display portion with a single hand. In embodiments, the resistance or friction provided by the hinges may be calibrated with respect to the force provided by the spring wire to achieve a desired opening behavior.

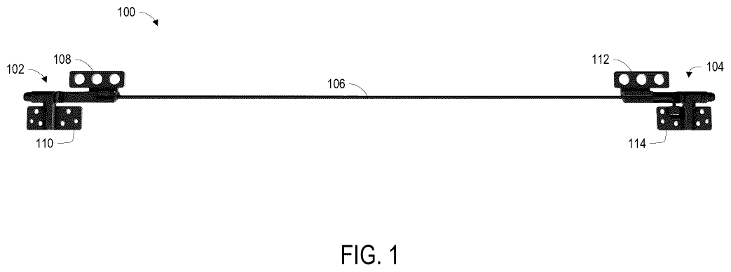

FIG. 1 depicts an example laptop computer hinge system 100 that is configured with a spring wire to automatically open at least partially. Hinge system 100, according to embodiments, includes a first, or left hinge 102, a second, or right hinge 104, which are each connected via a spring wire 106. Each hinge, in embodiments, includes a display portion and a base portion. Accordingly, first hinge 102 includes first display portion 108 and first base portion 110, and second hinge 104 includes second display portion 112 and second base portion 114. As will be understood, spring wire 106 in the depicted embodiment is secured to the base portion of one of the hinges, and to the display portion of the other hinge, so that the spring wire 106 can act to bias both hinges, as will be explained herein. In use, example hinge system 100 secures a laptop computer display to a laptop computer base in an articulating fashion. The laptop computer display is thus able to pivot, via hinge system 100, relative to the laptop computer base.

Spring wire 106, in embodiments, is constructed from a suitable elastic material that can be repeatedly tensioned, such as by twisting, yet not deform, and also provide a biasing force against the direction the material is tensioned. In the depicted embodiment, spring wire 106 is a single round rod of material. In some examples, spring wire 106 is constructed from spring steel or another metal or material with similarly suitable properties. In other examples, spring wire 106 may be constructed from multiple strands of material, or from a combination of different materials, such as metal and plastic or a composite. In still other examples, spring wire 106 may have a different profile than round; some portions or all of spring wire 106 may be flattened, ovoid, polygonal, or another cross-section or profile depending upon the needs of a given implementation.

While spring wire 106 is configured to be attached to a display portion of one hinge and a base portion of the other hinge so that the spring wire 106 is twisted into tension as the display of the laptop computer is closed to the base of the laptop computer, other arrangements may be possible. In another possible embodiment, spring wire 106 may be secured along its shaft, between first hinge 102 and second hinge 104. For example, spring wire 106 may be fixedly secured to either the laptop computer base or laptop computer display between the hinges. In such a configuration, spring wire 106 would be secured to the display portion of both first hinge 102 and second hinge 104 (if spring wire 106 is secured to the laptop computer base), or the base portion of both first hinge 102 and second hinge 104 (if spring wire 106 is secured to the laptop computer display).

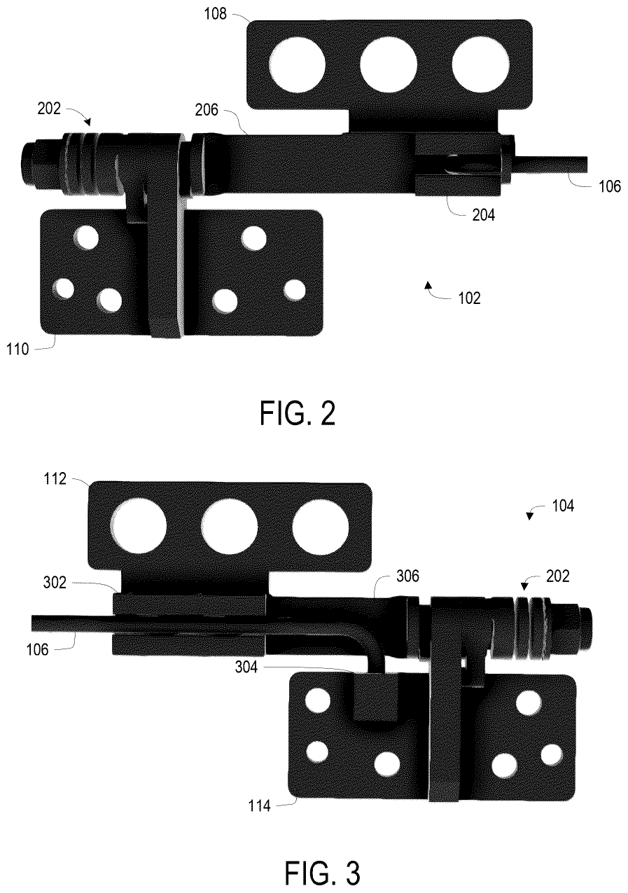

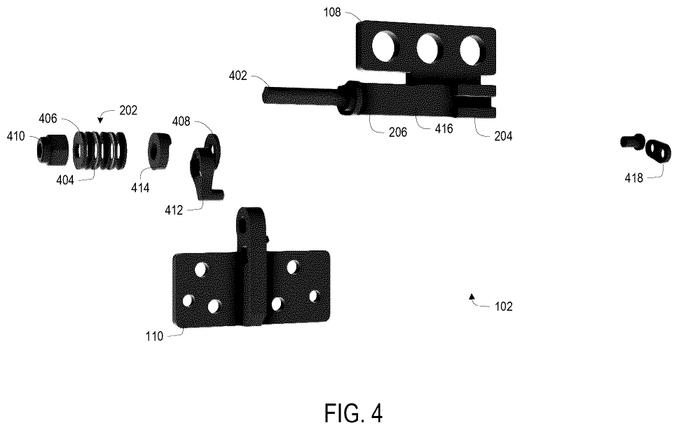

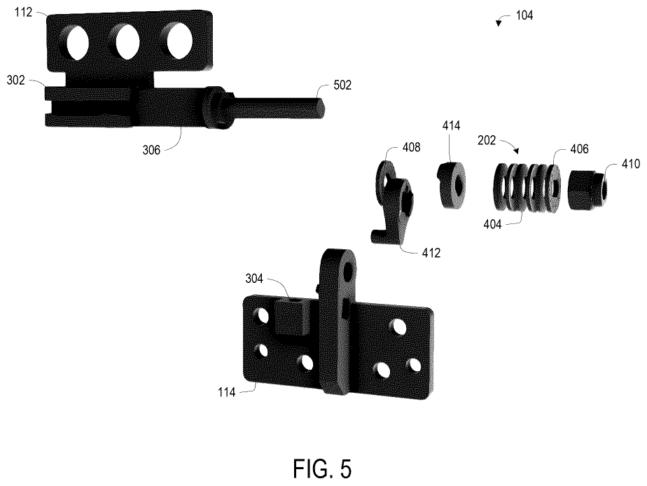

FIGS. 2 and 3 illustrate the components of the first hinge 102 (FIG. 2) and second hinge 104 (FIG. 3). With respect to FIG. 2, first hinge 102 includes first display portion 108 and first base portion 110. First display portion 108 and first base portion 110 are coupled to first hinge body 206. With respect to FIG. 3, the example second hinge 102 includes second display portion 112 and second base portion 114 are coupled to second hinge body 306. In the depicted embodiment of FIGS. 2 and 3, the display portions 108 and 112 are respectively fixedly coupled to first hinge body 206 and second hinge body 306. First base portion 110 and second base portion 114 are pivotably coupled to the respective first hinge body 206 and second hinge body 306. First base portion 110 and second base portion 114 secure to first hinge body 206 and second hinge body 306, respectively, via a spring washer assembly 202. The construction of spring washer assembly 202 will be discussed in greater detail below, with respect to FIGS. 4 and 5.

One end of spring wire 106 is coupled to first hinge 102 via a first fixing bracket 204. In the depicted embodiment, the end of spring wire 106 may be bent into an “L” to form a right-angle protrusion. The protrusion may then be inserted into first fixing bracket 204, such as into an aperture within or that passes through first fixing bracket 204. As can be seen in FIG. 2, first fixing bracket 204 may form a channel or recess into which a portion of spring wire 106 inserts, to help provide stability to the connection of spring wire 106 to first hinge 102. First fixing bracket 204 further serves to help transfer force to and from spring wire 106, to allow spring wire 106 to bias first hinge 102 into an open position, and to allow first hinge 102 to load spring wire 106 with a twisting force. First fixing bracket 204 is disposed upon first hinge body 206. Because, in the depicted embodiment, first hinge body 206 is fixedly coupled to first display portion 108, any movement of first display portion 108 either accepts force from or imparts force to spring wire 106. When base portion 110 is tied to an external stationary object (such as the base of a laptop computer), spring wire 106 can bias the first display portion 108 away from the base portion 110, at least until the spring wire 106 is fully unloaded.

In FIG. 3, a second end of spring wire 106, distal from first hinge 102, passes through a guide block 302 disposed upon second hinge body 306. The second end of the spring wire 106 is then secured into a second fixing bracket 304, which is disposed upon the second base portion 114. In the depicted embodiment, the end is bent approximately 90 degrees, and inserted into an aperture formed into the second fixing bracket 304. Because the second fixing bracket 304 is affixed to second base portion 114, the spring wire 106 can impart force to, or receive force from, the second base portion 114.

With the first end of the spring wire 106 coupled to the first display portion 108 and the second end of the spring wire 106 coupled to the second base portion 108, spring wire 106 can bias both the first hinge 102 and the second hinge 104 to an open position when the first base portion 110 and second base portion 114 are secured to a stationary object, such as a laptop computer base. When so secured, the first base portion 110 and second base portion 114 are effectively tied together. As a result, the spring wire 106 will impart an opening force to first display portion 108 via its coupling to first fixing bracket 204. When the first display portion 108 and second display portion 112 are both coupled to a laptop computer display, the spring wire 106 can cause the laptop computer display to at least partially open via the force imparted to first display portion 108. It will be understood that the spring wire 106 imparts an equal force to the second base portion 114 as it imparts to the first display portion 108. However, by virtue of tying the first and second base portions 110 and 114 together to a single laptop computer base, the full force imparted by spring wire 106 is transmitted to the first display portion 108, which opens due to its pivoting relationship with the first base portion 110.

As mentioned above, in other embodiments, spring wire 106 could be secured about its shaft between first hinge 102 and second hinge 104. In such a configuration, spring wire 106 would be secured to both of first display portion 108 and second display portion 112, where spring wire 106 is fixedly secured to a laptop computer base about its shaft and the first and second display portions 108 and 112 are secured to the laptop computer display. Alternatively, spring wire 106 could secure to both of first base portion 110 and second base portion 114, where spring wire 106 is fixedly secured to a laptop computer display about its shaft, with the first and second base portions 110 and 114 are secured to the laptop computer base. Spring wire 106 would thus impart equal force to either both first and second display portions 108 and 112, or to both first and second base portions 110 and 114, respectively. In either configuration, the force imparted by the spring wire 106 would urge the first and second hinges 102 and 104 to at least a partially open position.

As will be understood by a person skilled in the art, first and second display portions 108 and 112, and first and second base portions 110 and 114, each may be equipped with one or more apertures for securing to a laptop computer display and base, respectively. The number, pattern, and shape of the apertures may vary depending upon the needs of a specific implementation. In other embodiments, first and second display portions 108 and 112 and/or first and second base portions 110 and 114 may secure to their respective display and base using any suitable means, e.g. clamps, locks, notches, hooks, protrusions, etc.

FIGS. 4 and 5 depict the components of example first hinge 102 (FIG. 4) and example second hinge 104 (FIG. 5), respectively, in exploded view. In particular, FIGS. 4 and 5 depict the components of spring washer assembly 202, according to some embodiments. Referring to FIG. 4, in the depicted embodiment first display portion 108 includes first hinge body 206, upon which first fixing bracket 204 is disposed. First hinge body 206 has at least one flat surface 416, which may form a plane roughly parallel to the axis of rotation of first hinge 102. First fixing bracket 204 is oriented so that spring wire 106, when inserted, is held so that the longitudinal axis of spring wire 106 is disposed approximately concentric with the axis of rotation of first hinge 102. In embodiments, spring wire 106 may be secured into first fixing bracket 204 via a spring wire retainer 418. Spring wire 106 may be passed through an aperture in spring wire retainer 418, which in turn is secured to first hinge body 206.

FIG. 4 also depicts shaft 402 that extends from first hinge body 206 along the axis of rotation of first hinge 102, according to embodiments. Shaft 402 provides the core upon which spring washer assembly 202 is assembled. Spring washer assembly 202 includes one or more spring washers 404, sandwiched between a first friction disc 406 at one end, and against cam 414, lever arm 412, and a second friction disc 408. The spring washer assembly 202 is secured upon shaft 402 with a locking nut 410. By varying the degree to which locking nut 410 is secured to shaft 402, the one or more spring washers 404 can be preloaded to a predetermined amount. When preloaded, the spring washers 404 provide an expanding force along the longitudinal axis of shaft 402, which is coincident with the axis of rotation of first hinge 102. The expanding force urges cam 414 against lever arm 412, and imposes a load upon first and second friction discs 406 and 408. Lever arm 412 engages with first base portion 110, and so is held in a fixed position relative to first display portion 108 as first hinge 102 rotates.

Cam 414, in embodiments, is configured to intermittently engage with lever arm 412, which may be equipped with protrusions that interact with cam 414. When cam 414 is not engaged with lever arm 412, cam 414 may rotate, along with first friction disc 406 as well as spring washers 404, with shaft 402, as shaft 402 rotates when first display portion 108 is rotated relative to first base portion 110. When cam 414 engages with lever arm 412, as lever arm 412 is coupled to first base portion 110, cam 414 is held fixed as shaft 402 rotates with first display portion 108. When cam 414 is held fixed, the spring washer assembly 202 likewise may be held fixed. As a result, locking nut 410 may rotate with shaft 402 against first friction disc 406. This interaction between locking nut 410 and first friction disc 406 can provide a resistance to further rotating of first display portion 108 relative to first base portion 110. This resistance, in turn, enables first hinge 102 to be placed at a desired angle of opening, so that an attached laptop computer display can be positioned at a desired angle for use relative to the base of the laptop computer. By employing cam 414 and lever arm 412, resistance from first friction disc 406 does not engage until first hinge 102 is opened to a predetermined angle, the predetermined angle established by the position of the protrusions on cam 414 that interact with the corresponding protrusions on lever arm 412.

In some embodiments, second friction disc 408, being located between lever arm 412 and the side of first hinge body 206, can provide a constant amount of friction across the entire range of rotation of first hinge 102, to achieve a desired feel for opening an associated laptop computer. Depending upon the positioning of the protrusions on lever arm 412 and cam 414, second friction disc 408 alone may provide resistance for a portion of the travel of first hinge 102, with first friction disc 406 contributing friction once the first hinge 102 is opened to the predetermined angle. As will be explained herein, second friction disc 408 may be selected and configured to provide a balance against a biasing force supplied by spring wire 106, to allow the speed at which a laptop computer opens to be fine tuned. Positioning of the protrusions of lever arm 412 and cam 414 can further be selected to allow first friction disc 406 to come into play once the laptop computer is opened to a predetermined angle, to slow or arrest the automatic opening action. Further, employing the first friction disc 406 and second friction disc 408 in a staged fashion can allow for a laptop computer that is easy to initially open, yet allows the laptop computer display to be positioned at an appropriate working angle without further movement.

FIG. 5 depicts an exploded view of the components of second hinge 104. Second hinge 104 has comparable components to first hinge 102, and the reader is directed to the foregoing discussion of the components of the spring washer assembly 202 with respect to FIG. 4. As with first hinge 102, second hinge 104 includes a second hinge body 306, from which extends a shaft 502, to which the components of the spring washer assembly 202 are attached. Second display portion 112 includes guide block 302, with second base portion 114 including second fixing bracket 304. Lever arm 412 interacts with second base portion 114 to be held fixed while second display portion 112 rotates.

It should be understood that the configuration of spring washer assembly 202 can be fine tuned to achieve a desired laptop opening behavior. This fine tuning can be accomplished by adding or removing one or more of the spring washers 404, modifying, adding, or removing one or more of the first friction disc 406 and/or second friction disc 408, adjusting the amount of preload imposed by tightening or loosening locking nut 410, and/or by adjusting the point where the cam 414 engages with lever arm 412. Furthermore, the amount of friction imposed by both first friction disc 406 and second friction disc 408 are determined by the degree to which locking nut 410 is tightened as well as the selection and number of spring washers 404.

This fine tuning may be done with respect to the characteristics of spring wire 106 and/or the weight of a laptop computer display that is coupled to first and second hinges 102 and 104. For example, where a laptop computer is equipped with a comparatively heavy display panel, the preload upon spring washer assembly 202 may be reduced for a given spring wire 106, so that more of the force exerted by spring wire 106 is transferred to the display panel, rather than being dampened by second friction disc 408 and/or first friction disc 406, depending upon the configuration of lever arm 412 and cam 414 as well as the degree to which the laptop computer is opened. Conversely, where a laptop computer is equipped with a comparatively light display panel, the preload upon spring washer assembly 202 may be increased for a given spring wire 106, as the amount of force needed from spring wire 106 is comparatively less. A greater preload can thus tune the speed at which the display opens, so that the display does not open too rapidly. Alternatively or additionally, spring wire 106 may be modified, e.g. by changing weights, degree of preload, and or spring material, to provide an amount of biasing force that is targeted to a given laptop display panel weight.

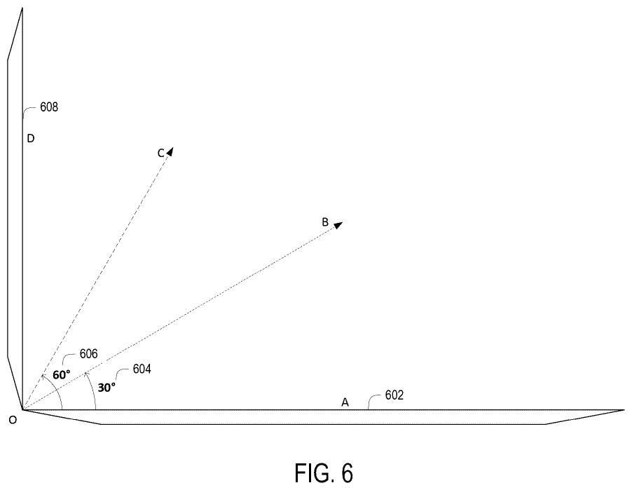

Turning to FIG. 6, an example laptop computer is depicted in profile view with several angular regions depicted to define the action of the hinge system 100. Laptop computer base 602 forms an initial plane A, while laptop computer display 608 defines a plane D. When the laptop computer is closed, plane A and plane D are substantially parallel, if not touching, as will be understood. As display 608 is opened, it pivots up away from the base 602, pivoting at origin point O. A first region 604 is defined as the range between a fully closed laptop (planes A and D parallel) and a laptop where the display is approximately 30 degrees open, defined as plane B. A second region 606 is defined between 30 degrees open to 60 degrees open, from plane B to a second position defined as plane C. From plane C, the laptop display 608 may open further until reaching a stop. In the depicted laptop of FIG. 6, this is illustrated as a 90 degree position, where plane D is orthogonal to plane A. However, display 608 may be able to be opened past 90 degrees, up to a mechanical limit defined by the configuration of first and second hinges 102 and 104 and/or other components of the base 602 contacting with the display 608.

For first region 604, in embodiments, hinge system 100 may be configured to open automatically. This may be accomplished by the preload upon spring wire 106, imposed when the laptop is closed from a 90 degree open position, in conjunction with spring washer assemblies 202 that are each configured to only provide resistance from one friction disc (or no friction disc). In embodiments, the display 608 may be latched or otherwise mechanically secured to base 602 when closed. Upon unlatching, display 608 is then automatically rotated to at least 30 degrees by the biasing force supplied by spring wire 106. As discussed above, spring wire 106 biases at least first hinge 102 to an open position by supplying opposing forces against the first display portion 108 and second base portion 114.

Upon reaching second region 606, the degree of resistance imposed by hinge system 100 (such as by each spring washer assembly 202) may increase, such as where cam 414 and lever arm 412 begin to interact, and so cause a second friction disc (or first, if no friction disc is engaged in first region 604) to engage. Alternative or additionally, the amount of biasing force supplied by spring wire 106 may decrease as the spring wire 106 approaches its neutral and relaxed position. In this second region 606, the laptop display 608 may no longer open automatically, but may nevertheless be opened with a reduced effort compared to a conventional laptop computer, as the spring wire 106 can contribute a biasing force, albeit lesser than supplied within first region 604. Outside of first region 604 and second region 606, spring wire 106 may only contribute a negligible force, if any. Past second region 606, the display 608 is within a range of angles that are suitable for normal operation, and so the display 608 should be held at whatever angle it is placed, by virtue of the friction supplied from spring washer assembly 202.

It should be understood that the angular definitions of first region 604 and second region 606 are to an extent arbitrary. The angular positions of each region may vary depending upon the needs of a given implementation. Moreover, in some embodiments, the transition between first region 604 and second region 606 may be indistinct. In some embodiments, the amount of biasing provided by spring wire 106 and the speed of opening may gradually decrease as the display 608 rotates away from base 602. This may occur naturally, in some embodiments, if the amount of biasing force supplied by spring wire 106 decreases as the spring wire 106 is unloaded, e.g. moves towards its neutral or relaxed position.

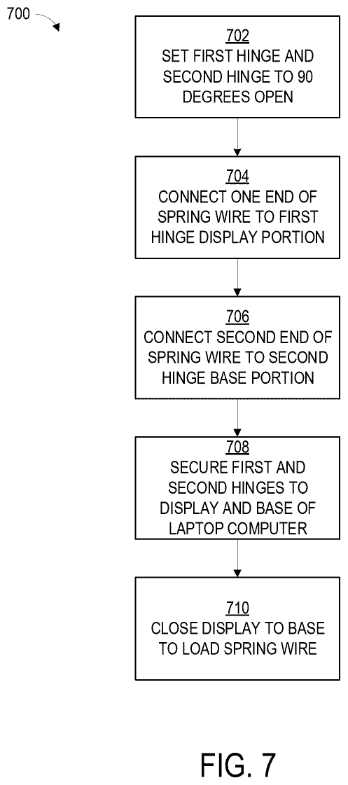

In FIG. 7, the operations of a method 700 for implementing a hinge system, such as hinge system 100 with first hinge 102 and second hinge 104 connected via spring wire 106, are shown. The operations of method 700 may be implemented in whole or in part, may be executed in or out of order as appropriate, and operations may be added or omitted, depending upon the needs of a given embodiment.

In operation 702, the first and second hinges are opened to approximately 90 degrees. This initial opening angle can establish the degree to which the spring wire is preloaded, with 90 degrees defining the neutral or relaxed position of the spring wire. In other embodiments, the first and second hinges may be opened to a different angle, depending upon the amount of desired preload upon the spring wire and/or depending upon where the neutral point of the spring wire is desired. For example, the first and second hinges may be opened to a greater angle, e.g. 135 degrees, to provide a greater preload, and/or where the display is anticipated to be routinely used at angles in excess of 90 degrees.

In operation 704, a first end of the spring wire is secured to a display portion of the first hinge. Although the end is inserted into a fixing bracket in the embodiments described above, the spring wire may be secured using any suitable mechanism or technique, so long as the spring wire is fixed relative to the display portion and is thus rotated as the display portion of the first hinge is rotated relative to a base portion.

In operation 706, a second end of the spring wire is secured to a base portion of the second hinge. As with operation 704, the end may be secured with a fixing bracket, or by any other suitable technique, so long as the spring wire is fixed relative to the base portion and is thus held fixed as the display portion of the first hinge is rotated.

In operation 708, the first and second hinges are attached to a laptop computer display and laptop computer base. As will be understood, the display portion of each hinge is secured to the display, and the base portion of each hinge is secured to the base.

In operation 710, the laptop computer display is closed from a 90 degree open position. As the display is closed, the spring wire is twisted via the movement of the display portion of the first hinge relative to the base portion of the second hinge. This twisting causes the spring wire to become loaded and to exert a counter pressure upon the display portion of the first hinge and the base portion of the second hinge. Thus, when the display is opened, the spring wire biases the display open automatically by pushing in opposing directions on the display portion of the first hinge and the base portion of the second hinge.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

Illustrative examples of the technologies disclosed herein are provided below. An embodiment of the technologies may include any one or more, and any combination of, the examples described below.

### Examples

The following examples pertain to further embodiments.

Example 1 is a hinge system for a laptop computer, comprising a first flexible hinge, comprising a first base half and a first display half pivotably coupled to the first base half; a second flexible hinge, comprising a second base half and a second display half pivotably coupled to the second base half; and a spring wire coupled to the first display half and the second base half, wherein the spring wire biases the first flexible hinge and the second flexible hinge from a closed to a partially open position, the first base half and second base half are each adapted to secure to a base portion of the laptop computer, and the first display half and second display half are each adapted to secure to a display portion of the laptop computer.

Example 2 includes the subject matter of example 1, wherein the first flexible hinge and the second flexible hinge each further comprise one or more spring washers, the spring washers to impose a predetermined resistance against hinge movement.

Example 3 includes the subject matter of example 1 or 2, wherein the first flexible hinge and the second flexible hinge each further comprise a plurality of friction discs that impose the predetermined resistance against the hinge movement.

Example 4 includes the subject matter of example 3, wherein the first flexible hinge and the second flexible hinge each further comprise a cam and lever arm arranged so that a first of the plurality of friction discs is engaged over a first range of hinge movement, and the first and a second of the plurality of friction discs is engaged over a second range of hinge movement.

Example 5 includes the subject matter of example 4, wherein the spring wire biases the first flexible hinge and the second flexible hinge to automatically open over the first range of hinge movement.

Example 6 includes the subject matter of any of examples 1-5, wherein the spring wire biases the first flexible hinge and the second flexible hinge so that the first flexible hinge and the second flexible hinge automatically open from a closed position to approximately 30 degrees open.

Example 7 includes the subject matter of any of examples 1-6, wherein the spring wire does not bias the first flexible hinge and the second flexible hinge when the first flexible hinge and the second flexible hinge are approximately 90 degrees open.

Example 8 is a laptop computer, comprising a base; a display; and a hinge system, the hinge system comprising a first flexible hinge, comprising a first base half coupled to the base and a first display half coupled to the display and pivotably coupled to the first base half; a second flexible hinge, comprising a second base half coupled to the base and a second display half coupled to the display and pivotably coupled to the second base half; and a spring wire coupled to the first display half and the second base half, wherein the spring wire biases the display away from the base from a closed position to a partially open position.

Example 9 includes the subject matter of example 8, wherein the first flexible hinge and the second flexible hinge each further comprise one or more spring washers.

Example 10 includes the subject matter of example 8 or 9, wherein the first flexible hinge and the second flexible hinge each further comprise a plurality of friction discs that impose the predetermined resistance against hinge movement.

Example 11 includes the subject matter of example 10, wherein the first flexible hinge and the second flexible hinge each further comprise a cam and lever arm arranged so that a first of the plurality of friction discs is engaged over a first range of hinge movement, and the first and a second of the plurality of friction discs is engaged over a second range of hinge movement.

Example 12 includes the subject matter of example 11, wherein the spring wire biases the display to automatically open away from the base over the first range of hinge movement.

Example 13 includes the subject matter of any of examples 8-12, wherein the spring wire biases the display away from the base to automatically open from a closed position to approximately 30 degrees open.

Example 14 includes the subject matter of any of examples 8-13, wherein the spring wire does not bias the display when the display is approximately 90 degrees open from the base.

Example 15 is a method, comprising connecting, with a spring wire, a first end of the spring wire to a display half of a first flexible hinge; connecting, with the spring wire, a second end of the spring wire to a base half of a second flexible hinge; securing, to the display half of the first flexible hinge and to a display half of the second flexible hinge, a display of a laptop computer; securing to a base half of the first flexible hinge and the base half of the second flexible hinge, a base of the laptop computer; and pre-loading the spring wire so that the spring wire is biased to cause the display to automatically open away from the base from a closed position.

Example 16 includes the subject matter of example 15, wherein pre-loading the spring wire comprises pre-loading the spring wire so that it does not supply a biasing force when the display is positioned approximately perpendicular to the base of the laptop computer.

Example 17 includes the subject matter of example 15 and 16, further comprising securing, to each of the first flexible hinge and second flexible hinge, one or more spring washers, the one or more spring washers providing a resistance to movement of the first flexible hinge and second flexible hinge.

Example 18 includes the subject matter of any of examples 15-17, further comprising selecting a number of the one or more spring washers, for securing to each of the first flexible hinge and second flexible hinge, that results in the display of the laptop computer automatically opening away from the base of the laptop computer to approximately 30 degrees from the closed position.

Example 19 includes the subject matter of examples 15-18, further comprising selecting, for securing to each of the first flexible hinge and the second flexible hinge, a plurality of friction discs that impose a predetermined resistance against hinge movement.

Example 20 includes the subject matter of example 19, further comprising providing, for the first flexible hinge and the second flexible hinge, a cam and lever arm arranged so that a first of the plurality of friction discs is engaged over a first range of hinge movement, and the first and a second of the plurality of friction discs is engaged over a second range of hinge movement.

1-20. (canceled)

21. A hinge system for a laptop computer, comprising:
a first flexible hinge, comprising a first base half and a first display half pivotably coupled to the first base half;
a second flexible hinge, comprising a second base half and a second display half pivotably coupled to the second base half; and
a spring wire coupled to the first display half and the second base half,
wherein:
the spring wire biases the first flexible hinge and the second flexible hinge from a closed to a partially open position,
the first base half and second base half are each adapted to secure to a base portion of the laptop computer, and
the first display half and second display half are each adapted to secure to a display portion of the laptop computer.

22. The system of claim 21, wherein the first flexible hinge and the second flexible hinge each further comprise one or more spring washers, the spring washers to impose a predetermined resistance against hinge movement.

23. The system of claim 21, wherein the spring wire coupled to the first display half and the second base half comprises a first end of the spring wire coupled to the first display half, and a second end of the spring wire coupled to the second base half.

24. The system of claim 21, wherein the first flexible hinge and the second flexible hinge each further comprise a cam and lever arm arranged so that a first of the plurality of friction discs is engaged over a first range of hinge movement, and the first and a second of the plurality of friction discs is engaged over a second range of hinge movement.

25. The system of claim 24, wherein the spring wire biases the first flexible hinge and the second flexible hinge to automatically open over the first range of hinge movement.

26. The system of claim 21, wherein the spring wire biases the first flexible hinge and the second flexible hinge so that the first flexible hinge and the second flexible hinge automatically open from a closed position to approximately 30 degrees open.

27. The system of claim 26, wherein the spring wire does not bias the first flexible hinge and the second flexible hinge when the first flexible hinge and the second flexible hinge are approximately 90 degrees open.

28. A laptop computer, comprising:
a base;
a display; and
a hinge system, the hinge system comprising:
a first flexible hinge, comprising a first base half coupled to the base and a first display half coupled to the display and pivotably coupled to the first base half;
a second flexible hinge, comprising a second base half coupled to the base and a second display half coupled to the display and pivotably coupled to the second base half; and
a spring wire coupled to the first display half and the second base half,
wherein the spring wire biases the display away from the base from a closed position to a partially open position.

29. The laptop computer of claim 28, wherein the first flexible hinge and the second flexible hinge each further comprise one or more spring washers.

30. The laptop computer of claim 28, wherein the spring wire coupled to the first display half and the second base half comprises a first end of the spring wire coupled to the first display half, and a second end of the spring wire coupled to the second base half.

31. The laptop computer of claim 30, wherein the first flexible hinge and the second flexible hinge each further comprise a cam and lever arm arranged so that a first of the plurality of friction discs is engaged over a first range of hinge movement, and the first and a second of the plurality of friction discs is engaged over a second range of hinge movement.

32. The laptop computer of claim 31, wherein the spring wire biases the display to automatically open away from the base over the first range of hinge movement.

33. The laptop computer of claim 28, wherein the spring wire biases the display away from the base to automatically open from a closed position to approximately degrees open.

34. The laptop computer of claim 28, wherein the spring wire does not bias the display when the display is approximately 90 degrees open from the base.

35. A method, comprising:
connecting, with a spring wire, a first end of the spring wire to a display half of a first flexible hinge;
connecting, with the spring wire, a second end of the spring wire to a base half of a second flexible hinge;
securing, to the display half of the first flexible hinge and to a display half of the second flexible hinge, a display of a laptop computer;
securing to a base half of the first flexible hinge and the base half of the second flexible hinge, a base of the laptop computer; and
pre-loading the spring wire so that the spring wire is biased to cause the display to automatically open away from the base from a closed position.

36. The method of claim 35, wherein pre-loading the spring wire comprises pre-loading the spring wire so that it does not supply a biasing force when the display is positioned approximately perpendicular to the base of the laptop computer.

37. The method of claim 35, further comprising securing, to each of the first flexible hinge and second flexible hinge, one or more spring washers, the one or more spring washers providing a resistance to movement of the first flexible hinge and second flexible hinge.

38. The method of claim 37, further comprising selecting a number of the one or more spring washers, for securing to each of the first flexible hinge and second flexible hinge, that results in the display of the laptop computer automatically opening away from the base of the laptop computer to approximately 30 degrees from the closed position.

39. The method of claim 38, further comprising selecting, for securing to each of the first flexible hinge and the second flexible hinge, a plurality of friction discs that impose a predetermined resistance against hinge movement.

40. The method of claim 39, further comprising providing, for the first flexible hinge and the second flexible hinge, a cam and lever arm arranged so that a first of the plurality of friction discs is engaged over a first range of hinge movement, and the first and a second of the plurality of friction discs is engaged over a second range of hinge movement.
